(19) United States
(12) Patent Application Publication
(10) Pub. No.: US 2008/0039558 A1
(43) Pub. Date: Feb. 14, 2008

(54) Perfluorinated Esters, Polyester, Ethers and Carbonates

(76) Inventors: Dario Lazzari, Bologna (IT); Francesca Peri, Bologna (IT); Martin Brunner, Wallbach (CH); Alessandro Zedda, Basel (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/596,732

(22) PCT Filed: May 18, 2005
(86) PCT No.: PCT/EP05/52267

§ 371 Date: Nov. 16, 2006

(30) Foreign Application Priority Data
May 25, 2004 (EP) 04102281.5

(51) Int. Cl. C08L 1/00; C08G 75/00

(52) U.S. Cl. 524/13; 528/360

(57) ABSTRACT

The present instant invention relates to new compounds of the formula (I) wherein T is H or R; R is R₁, —CO—R₂, —CO—R₃—COOH, —COO—R₄ or R₅; R₁ is independently Formula (II) or Formula (III); and to compositions comprising these novel compounds and natural, synthetic or semisynthetic material. Such compounds are useful as water and/or oil repellents.

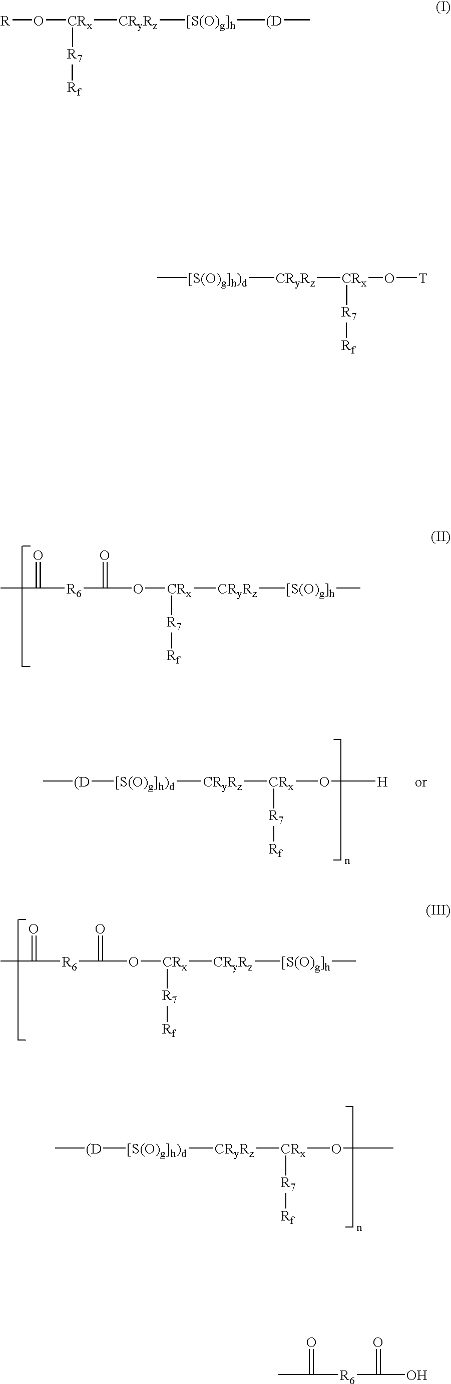

The present invention relates to novel esters, polyester, carbonates and ethers with perfluoroalkyl groups and to compositions comprising these novel compounds and natural, synthetic or semisynthetic material. Such compounds are useful as water and/or oil repellents.

U.S. Pat. No. 5,708,119, U.S. Pat. No. 5,693,747 and EP-A-0 694 532 disclose bisperfluoroalkyl-substituted diols containing sulfide, sulfone of polysulfide linkages and urethane, polyurethane, carbonate, ester and polyester derivatives thereof. These diols and their derivatives can be used to impart oil and water repellency to various substrates.

U.S. Pat. No. 6,387,999 discloses compositions comprising esters with perfluoroalkyl groups and oglio- or polyurethane which may also contain perfluoroalkyl groups. Such compositions are useful as oil and water repellents for sheetlike textile materials.

EP-A-0 690 039 discloses di-, tri- and poly-perfluoroalkyl-substituted alcohols and acids and derivatives thereof for oil- and water-repellent treatment of textiles, glass, paper and leather.

U.S. Pat. No. 5,807,977 and WO-A-96/21657 disclose fluorinated polymers and prepolymers derived from mono-substituted oxatane monomers having fluorinated alkoxymethylene side-chains. These prepolymers are amorphous oils with primary hydroxy end-groups and thus function as the soft block for the synthesis of a variety of thermoset/thermoplastic elastomers and plastics having the characteristics of very low surface energy, high hydrophobicity, low glass transition temperature and low coefficient of friction.

The use of various fluorochemical compositions on fibers and fibrous substrates, such as for example textiles, carpets, paper, leather and non-woven webs, on films and molded articles to impart oil and water repellency is known for example in U.S. Pat. No. 6,127,485. This reference discloses hydrophobic and oleophobic fibers, films and molded articles comprising synthetic organic polymer wherein dispersed within the fiber, fabric or molded article and present at the surface of the fiber, fabric or molded article are fluorochemical compounds.

It has now been found that the novel compounds of this invention are useful for various technical applications such as water and/or oil repellant or as reducers of surface energy for natural, synthetic or semi-synthetic materials, preferably natural, synthetic or semi-synthetic polymers. Polymers with such a reduced surface energy possess an “easy to clean”, “self-cleaning” “antisoiling”, “soil-release”, “antigraffiti”, “oil resistance”, “solvent resistance”, “chemical resistance”, “self lubricating”, “scratch resistance”, “low moisture absorption” and “hydrophobic” surface.

The present invention pertains to compounds of the formula I 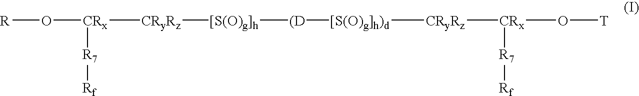
wherein
T is hydrogen or R;
R is independently R₁, —CO—R₂, —CO—R₃—COOH, —COOR₄ or R₅;
R₁ is independently 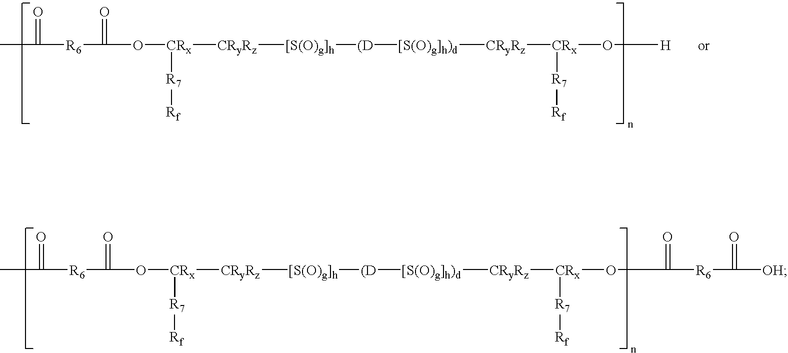
R₂ is independently C₃-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl, C₂-C₅-alkoxycarbonyl or C₂-C₅-alkanoyloxy; or R₂ is independently 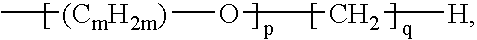
a poly(tetrahydrofuran) residue, a poly(phenylene ether) residue or perfluorinated C₁-C₂₀alkyl;
R₃ and R₆ are independently C₄-C₂₀alkenylene or C₂-C₂₀alkynylene; whereby each of these groups is unsubstituted or substituted by one or more chlorine, bromine or C₁-C₄alkyl groups; or R₃ and R₆ are independently 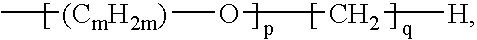
a poly(tetrahydrofuran) residue, a poly(phenylene ether) residue or perfluorinated C₁-C₂₀alkyl;
R₄ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl, C₂-C₅-alkoxycarbonyl or C₂-C₅-alkanoyloxy; or R₄ is independently 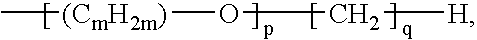
a poly(tetrahydrofuran) residue, a poly(phenylene ether) residue or perfluorinated C₁-C₂₀alkyl;
R₅ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl C₂-C₅-alkoxycarbonyl or C₂-C₅-alkanoyloxy; or R₅ is independently 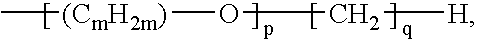
a poly(tetrahydrofuran) residue, a poly(phenylene ether) residue or perfluorinated C₁-C₂₀alkyl;
R₇ is independently a direct bond, C₁-C₆alkylene, alkyleneoxyalkylene of 2 to 6 carbon atoms, alkylenethioalkylene of 2 to 6 carbon atoms, C₁-C₆alkyleneoxy, alkenyleneoxyalkylene of 2 to 6 carbon atoms, alkylenethioalkyleneoxyalkylene of 3 to 9 carbon atoms; carbonamidoalkylene where the alkylene moiety contains 1 to 6 carbon atoms and the amido nitrogen is unsubstituted or further substituted by C₁-C₅alkyl, sulfonamidoalkylene wherein the alkylene moiety contains 1 to 6 carbon atoms and the amido nitrogen is unsubstituted or further substituted by C₁-C₅alkyl, carbonamidoalkylenethioalkylene wherein the carbonamidoalkylene moiety is as defined herein above and the thioalkylene moiety contains 1 to 6 carbon atoms, or sulfonamidoalkylenethioalkylene wherein the sulfonamidoalkylene moiety is as defined herein above and the thioalkylene moiety contains 1 to 6 carbon atoms, with the proviso that when g is 1 or 2, R₇ does not contain a thio group;
Rₓ, R_{y}, and R_{z} are independently of each other C₁-C₅alkyl or hydrogen;
h is 1 or 2;
g is 0, 1 or 2, with the proviso that when h is 2, g is 0;
d is 0 or 1;
D is C₂-C₁₀alkylene, alkyleneoxyalkylene of 4 to 10 carbon atoms, pentaerythrityl diacetate or pentaerythrityl dipropionate;
n is 1 to 20;
m is 2 to 4;
p is 2 to 30;
q is 1 or 2; and
R_{f} is independently perfluorinated alkyl, alkenyl or cycloalkyl having 3 to 20 fully fluorinated carbon atoms.

Preferably, in compounds of the formula I, T is R.

For example, R is R₁, —CO—R₂, —CO—R₃—COOH, —COO—R₄ or R₅.

R₇ is a divalent group that may be incorporated in formula I either way.

Denotations such as alkyleneoxyalkylene of 2 to 6 carbon atoms are to be understood that this group is C₁-C₅alkyleneoxyC₁-C₅alkylene whereby the group contains a maximum of 6 carbon atoms. The reminder of the definitions is to be understood in an analoguous manner.

Preferably, R₇ is a direct bond, —CH₂—, —CH(CH₃)—, —CH₂CH₂—O—CH₂—, —CH₂CH₂—S—CH₂—, —CH═CHCH₂—O—CH₂—, —SO₂NR₈—CH₂— or —CONH—CH₂CH₂—O—CH₂—, especially —CH₂—.

R₈ is hydrogen or C₁-C₄alkyl.

Preferred are compounds, wherein Rₓ is hydrogen or methyl, for example hydrogen. Preferably, R_{y} and R_{z} are independently hydrogen or methyl, especially hydrogen.

Preferably, h is 1.

Of interest are compounds of the formula I, wherein g is 1 or 2. Of special interest are compounds of the formula I, wherein g is 0.

Preferably, d is 1. Also preferably, d is 0.

For example, D is —CH₂CH—O—CH₂CH₂—, pentaerythrityl diacetate or pentaerythrityl dipropionate.

Preferably, n is 1 to 10, for example n is 1 to 5.

Preferably, m is 2.

Preferably, p is 2 to 20. Most preferably, p is 2 to 10.

Preferably, q is 1. Also preferably, q is 2.

R_{f} may be a mixture perfluorinated alkyl homologues or a mixture of perfluorinated alkenyl homologues or a mixture of perfluorinated cycloalkyl homologues as for example a mixture of perfluorinated C₃-C₂₀alkyl or a mixture of perfluorinated C₄-C₁₈alkyl or a mixture of perfluorinated C₄-C₁₄alkyl. Preferred are compounds of formula I, wherein R_{f} is perfluorinated C₄-C₁₈alkyl, for example linear perfluorinated C₄-C₁₄alkyl.

Preferably, R₂ is independently C₄-C₂₀alkenyl, C₂-C₂₀alkynyl, C₄-C₁₀cycloalkyl, C₈-C₁₈aralkenyl or C₈-C₁₆aralkynyl; or R₂ is independently 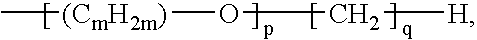
a poly(tetrahydrofuran) residue, a poly(phenylene ether) residue or perfluorinated C₁-C₂₀alkyl. More preferably, R₂ is independently C₄-C₂₀alkenyl, C₂-C₂₀alkynyl, C₈-C₁₆aralkenyl or C₈-C₁₆aralkynyl; or R₂ is independently 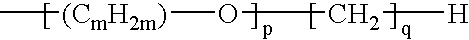
or perfluorinated C₁-C₂₀alkyl. Most preferably, R₂ is C₄-C₂₀alkenyl, C₂-C₂₀alkynyl or C₈-C₁₆aralkenyl; or R₂ is 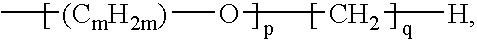
or perfluorinated C₁-C₂₀alkyl.

Of interest are compounds of the formula I, wherein R₃ is independently C₄-C₂₀alkenylene or C₂-C₂₀alkynylene; or R₃ is independently 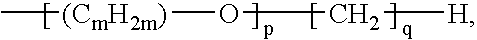
a poly(tetrahydrofuran) residue, a poly(phenylene ether) residue or perfluorinated C₁-C₂₀alkyl. Of special interest are compounds of the formula I, wherein R₃ is independently C₄-C₂₀alkenylene or C₂-C₂₀alkynylene; or R₃ is independently 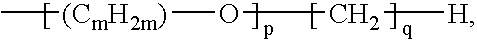
or perfluorinated C₁-C₂₀alkyl. For example, R₃ is C₄-C₂₀alkenylene.

Preferably, R₄ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; or R₄ is independently 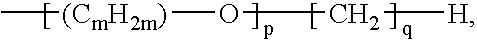
a poly(tetrahydrofuran) residue, a poly(phenylene ether) residue or perfluorinated C₁-C₂₀alkyl. More preferably, R₄ is independently C₁-C₂₀alkyl, C₆-C₁₄aryl, C₇-C₁₆aralkyl, C₂-C₂₀alkenyl, C₂-C₂₀alkynyl, C₈-C₁₆aralkenyl or C₈-C₁₆aralkynyl; or R₄ is independently 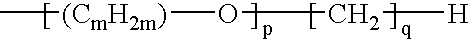
or perfluorinated C₁-C₂alkyl. For example, R₄ is C₂-C₂₀alkenyl or

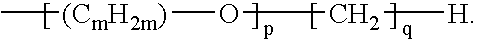

Compounds are preferred, wherein R₅ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; or R₅ is independently 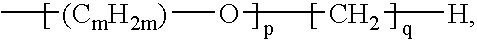
a poly(tetrahydrofuran) residue, a poly(phenylene ether) residue or perfluorinated C₁-C₂₀alkyl. Compounds are more preferred, wherein R₅ is independently C₁-C₂₀alkyl, C₆-C₁₄aryl, C₇-C₁₆aralkyl, C₂-C₂₀alkenyl, C₂-C₂₀alkynyl, C₄-C₈-C₁₆aralkenyl or C₈-C₁₆aralkynyl; or R₅ is independently 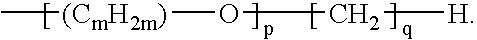
For example, R₅ is C₂-C₂₀alkenyl or

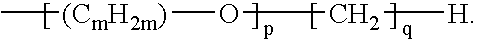

Preferably, R₆ is independently C₄-C₂₀alkenylene or C₂-C₂₀alkynylene; or R₆ is independently 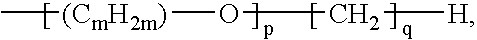
a poly(tetrahydrofuran) residue, a poly(phenylene ether) residue or perfluorinated C₁-C₂₀alkyl. More preferably, R₆ is independently C₄-C₂₀alkenylene or C₂-C₂₀alkynylene; or R₆ is independently 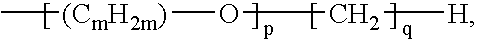
or perfluorinated C₁-C₂₀alkyl. Most preferably, R₆ is C₄-C₂₀alkenylene.

This invention also pertains to compounds obtainable by reacting a compound of formula II 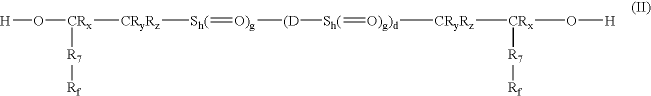
with at least one compound selected from the group consisting of R₂—COOH, R₂—COCl, R₂—COOR₉, HOOC—R₃—COOH, ClOC—R₃—COCl, R₉OOC—R₃—COOR₉, HOOC—R₆—COOH, ClOC—R₆—COCl, R₉OOC—R₆—COOR₉, R₄—O—COCl, R₅—Cl, R₅—Br and R₅—I;
whereby
R₂, R₃, R₄, R₅, R₆, R₇, Rₓ, R_{y}, R_{z}, h, g, d, D and R_{f} are as defined above and R₉ is C₁-C₅alkyl.

In the definitions of the above formula I and II the term alkyl comprises, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, 2-methylheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl or dodecyl.

Examples of alkenyl are vinyl, allyl, butenyl, pentenyl, hexenyl, heptenyl, octenyl, nonenyl, decenyl, undecenyl and dodecenyl. The term alkenyl also comprises residues with more than one double bond that may be conjugated or non-conjugated.

Examples of alkynyl are ethynyl, 1-propynyl, 2-propynyl, butynyl, pentynyl, hexynyl, heptynyl, octynyl, nonynyl, decynyl, undecynyl and dodecynyl. The term alkynyl also comprises residues with more than one triple bond that may be conjugated or non-conjugated.

Examples of alkenylene are vinylene, allylene, butenylene, pentenylene, hexenylene, heptenylene, octenylene, nonenylene, decenylene, undecenylene and dodecenylene. The term alkenylene also comprises residues with more than one double bond that may be conjugated or non-conjugated.

Examples of alkynylene are ethynylene, 1-propynylene, 2-propynylene, butynylene, pentynylene, hexynylene, heptynylene, octynylene, nonynylene, decynylene, undecynylene and dodecynylene. The term alkynylene also comprises residues with more than one triple bond that may be conjugated or non-conjugated.

Some examples of cycloalkyl are cyclobutyl, cyclopentyl, cyclohexyl, methylcyclopentyl, dimethylcyclopentyl and methylcyclohexyl.

Of interest is a composition comprising

a) a natural, synthetic or semisynthetic material, and

b) at least one compound of the present invention.

Any living matter such as humans, animals or any part of them is not included in the meaning of this natural, synthetic or semisynthetic material.

Preferred is a composition, wherein the component (a) is a plastic material, a coating, glass, wood, paper, leather, fibre material or textiles.

Of special interest is a composition, wherein the component (b) is present in an amount of 0.001% to 20%, more preferably in an amount of 0.01% to 10%, for example 0.1% to 5%, based on the weight of component (a).

Preferably, the natural, synthetic or semi-synthetic material is a natural, semi-synthetic or synthetic organic polymer, for example a synthetic organic polymer.

Illustrative examples of such natural, synthetic or semisynthetic materials are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature.
b) catalytic polymerisation using a catalyst that normally contains one or more than one metal of groups IVb, Vb, VIb or VII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Drying and non-drying alkyd resins.

23. Unsaturated polyester resins derived from copolyesters of saturated and unsaturated dicarboxylic acids with polyhydric alcohols and vinyl compounds as crosslinking agents, and also halogen-containing modifications thereof of low flammability.

24. Crosslinkable acrylic resins derived from substituted acrylates, for example epoxy acrylates, urethane acrylates or polyester acrylates.

25. Alkyd resins, polyester resins and acrylate resins crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

27. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

28. Blends and alloys of the aforementioned polymers (polyblends), for example PP/EPDM, Polyamide/EPDM or ABS, PVC/EVA, PVC/ABS, PVC/MBS, PC/ABS, PC/Polyester, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

29. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

30. Aqueous emulsions of natural or synthetic rubber, e.g. natural latex or latices of carboxylated styrene/butadiene copolymers.

In addition to comprising the compounds of the formula I, the inventive compositions may comprise further additives, typically the following:

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1, 3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of R-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenyl methane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octyl-phenothiazines, a mixture of mono- and dialkylated tert-octyl-phenothiazines, N-allylphenothiazine, N,N,N′,N′-tetraphenyl-1,4-diaminobut-2-ene.

2. UV absorbers and light stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂ [symbol] ₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.

2.5. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro-[4,5]decane, a reaction product of 7,7,9,9-tetramethyl-2-cycloundecyl-1-oxa-3,8-diaza-4-oxo-spiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2, 4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-(2-hydroxy-4-[3-(2-ethylhexyl-1-oxy)-2-hydroxypropyloxy]phenyl)-4,6-bis(2,4-dimethylphenyl)-1,3,5-triazine, 2,4-bis(4-[2-ethylhexyloxy]-2-hydroxyphenyl)-6-(4-methoxyphenyl-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-dicumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-[2-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene)sorbitol, and 1, 3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

Preferred IR absorbers are for example pigments, dyes or organometallic compounds. Examples of such pigments are for example disclosed in JP-A-2003221523. Examples of IR absorbing dyes are disclosed for example in JP-A-2003327865 or EP-A-1 306 404. IR absorbing organometallic compounds are for example disclosed in EP-A-1 266 931 or Chemical Abstract 117; 112529.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

The further additives are typically used in concentrations of 0.01 to 10%, based on the total weight of the material to be treated.

The novel compounds of the formula I can be used in particular together with phenolic antioxidants, light stabilizers and/or processing stabilizers.

Another part of this invention is the use of at least one compound of the present invention as an oil and/or water repellency agent for a natural, synthetic or semisynthetic material.

This invention also pertains to a process for imparting oil and/or water repellency to a natural, synthetic or semisynthetic material, characterized in that at least one compound of the pre-sent invention is applied to or incorporated in the said material.

The compounds of the formula I are suitable as water and/or oil repellants or as reducers of surface energy for natural, synthetic or semi-synthetic materials. For example, polymers with such a reduced surface energy possess an “easy to clean”, “self-cleaning” “antisoiling”, “soil-release”, “antigraffiti”, “oil resistance”, “solvent resistance”, “chemical resistance”, “self lubricating”, “scratch resistance”, “low moisture absorption” and “hydrophobic” surface.

To be singled out for special mention is the efficacy of the novel compounds of the formula I as water and/or oil repellents or as reducer of surface energy for natural, synthetic or semi-synthetic material.

Incorporation of component (b) and, if desired, further additives into the synthetic polymers is carried out by known methods, for example before or during compounding, extrusion, co-extrusion or else by applying the dissolved or dispersed compounds to the synthetic polymer, if appropriate with subsequent slow evaporation of the solvent.

The present invention also relates to a composition in the form of a masterbatch or concentrate comprising component (a) in an amount of from 5 to 90% and component (b) in an amount of from 5 to 80% by weight.

Component (b) and, if desired, further additives, can also be added before or during polymerisation or before crosslinking.

Component (b), with or without further additives, can be incorporated in pure form or encapsulated in waxes, oils or polymers into the synthetic polymer.

Component (b), with or without further additives, can also be sprayed onto the synthetic polymer. It is able to dilute other additives (for example the conventional additives indicated above) or their melts so that they too can be sprayed together with these additives onto the polymer. Addition by spraying on during the deactivation of the polymerization catalysts is particularly advantageous, it being possible to carry out spraying using, for example, the steam used for deactivation.

In the case of spherically polymerized polyolefins it may, for example, be advantageous to apply component (b), with or without other additives, by spraying.

The synthetic polymers prepared in this way can be employed in a wide variety of forms, for example as foams, films, fibres, tapes, moulding compositions, as profiles or as binders for coating materials, especially powder coatings, adhesives, putties or especially as thick-layer polyolefin mouldings which are in long-term contact with extractive media, such as, for example, pipes for liquids or gases, films, fibres, geomembranes, tapes, profiles or tanks.

The preferred thick-layer polyolefin mouldings have a layer thickness of from 1 to 50 mm, in particular from 1 to 30 mm, for example from 2 to 10 mm.

The compositions according to the invention can be advantageously used for the preparation of various shaped articles. Examples are:

I-1) Floating devices, marine applications, pontoons, buoys, plastic lumber for decks, piers, boats, kayaks, oars, and beach reinforcements.

I-2) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.

I-3) Road traffic devices, in particular sign postings, posts for road marking, car accessories, warning triangles, medical cases, helmets, tires.

I-4) Devices for plane, railway, motor car (car, motorbike) including furnishings.

I-5) Devices for space applications, in particular rockets and satellites, e.g. reentry shields.

I-6) Devices for architecture and design, mining applications, acoustic quietized systems, street refuges, and shelters.

II-1) Appliances, cases and coverings in general and electric/electronic devices (personal computer, telephone, portable phone, printer, television-sets, audio and video devices), flower pots, satellite TV bowl, and panel devices.

II-2) Jacketing for other materials such as steel or textiles.

II-3) Devices for the electronic industry, in particular insulation for plugs, especially computer plugs, cases for electric and electronic parts, printed boards, and materials for electronic data storage such as chips, check cards or credit cards.

II-4) Electric appliances, in particular washing machines, tumblers, ovens (microwave oven), dish-washers, mixers, and irons.

II-5) Covers for lights (e.g. street-lights, lamp-shades).

II-6) Applications in wire and cable (semi-conductor, insulation and cable-jacketing).

II-7) Foils for condensers, refrigerators, heating devices, air conditioners, encapsulating of electronics, semi-conductors, coffee machines, and vacuum cleaners.

III-1) Technical articles such as cogwheel (gear), slide fittings, spacers, screws, bolts, handles, and knobs.

III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.

III-3) Sanitary articles, in particular shower cubicles, lavatory seats, covers, and sinks.

III-4) Hygienic articles, in particular diapers (babies, adult incontinence), feminine hygiene articles, shower curtains, brushes, mats, tubs, mobile toilets, tooth brushes, and bed pans.

III-5) Pipes (cross-linked or not) for water, waste water and chemicals, pipes for wire and cable protection, pipes for gas, oil and sewage, guttering, down pipes, and drainage systems.

III-6) Profiles of any geometry (window panes) and siding.

III-7) Glass substitutes, in particular extruded or co-extruded plates, glazing for buildings (monolithic, twin or multiwall), aircraft, schools, extruded sheets, window film for architectural glazing, train, transportation, sanitary articles, and greenhouse.

III-8) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

III-9) Intake and outlet manifolds.

III-10) Cement-, concrete-, composite-applications and covers, siding and cladding, hand rails, banisters, kitchen work tops, roofing, roofing sheets, tiles, and tarpaulins.

IV-1) Plates (walls and cutting board), trays, artificial grass, astroturf, artificial covering for stadium rings (athletics), artificial floor for stadium rings (athletics), and tapes.

IV-2) Woven fabrics continuous and staple, fibers (carpets/hygienic articles/geotextiles/monofilaments; filters; wipes/curtains (shades)/medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags, and bags.

IV-3) Membranes, insulation, covers and seals for roofs, tunnels, dumps, ponds, dumps, walls roofing membranes, geomembranes, swimming pools, curtains (shades)/sun-shields, awnings, canopies, wallpaper, food packing and wrapping (flexible and solid), medical packaging (flexible & solid), airbags/safety belts, arm- and head rests, carpets, centre console, dashboard, cockpits, door, overhead console module, door trim, headliners, interior lighting, interior mirrors, parcel shelf, rear luggage cover, seats, steering column, steering wheel, textiles, and trunk trim.

V) Films (packaging, dump, laminating, agriculture and horticulture, greenhouse, mulch, tunnel, silage), bale wrap, swimming pools, waste bags, wallpaper, stretch film, raffia, desalination film, batteries, and connectors.

VI-1) Food packing and wrapping (flexible and solid), bottles.

VI-2) Storage systems such as boxes (crates), luggage, chest, household boxes, pallets, shelves, tracks, screw boxes, packs, and cans.

VI-3) Cartridges, syringes, medical applications, containers for any transportation, waste baskets and waste bins, waste bags, bins, dust bins, bin liners, wheely bins, container in general, tanks for water/used water/chemistry/gas/foil/gasoline/diesel; tank liners, boxes, crates, battery cases, troughs, medical devices such as piston, ophthalmic applications, diagnostic devices, and packing for pharmaceuticals blister.

VII-1) Extrusion coating (photo paper, tetrapack, pipe coating), household articles of any kind (e.g. appliances, thermos bottle/clothes hanger), fastening systems such as plugs, wire and cable clamps, zippers, closures, locks, and snap-closures.

VII-2) Support devices, articles for the leisure time such as sports and fitness devices, gymnastics mats, ski-boots, inline-skates, skis, big foot, athletic surfaces (e.g. tennis grounds); screw tops, tops and stoppers for bottles, and cans.

VII-3) Furniture in general, foamed articles (cushions, impact absorbers), foams, sponges, dish clothes, mats, garden chairs, stadium seats, tables, couches, toys, building kits (boards/figures/balls), playhouses, slides, and play vehicles.

VII-4) Materials for optical and magnetic data storage.

VII-5) Kitchen ware (eating, drinking, cooking, storing).

VII-b 6) Boxes for CD's, cassettes and video tapes; DVD electronic articles, office supplies of any kind (ball-point pens, stamps and ink-pads, mouse, shelves, tracks), bottles of any volume and content (drinks, detergents, cosmetics including perfumes), and adhesive tapes.

VII-7) Footwear (shoes/shoe-soles), insoles, spats, adhesives, structural adhesives, food boxes (fruit, vegetables, meat, fish), synthetic paper, labels for bottles, couches, artificial joints (human), printing plates (flexographic), printed circuit boards, and display technologies.

VII-8) Devices of filled polymers (talc, chalk, china clay (kaolin), wollastonite, pigments, carbon black, TiO₂, mica, nanocomposites, dolomite, silicates, glass, asbestos).

Of special interest are the shaped articles mentioned in IV-2 and textiles.

Thus, a further embodiment of the present invention relates to a shaped article, in particular a film, pipe, profile, bottle, tank or container, fiber containing a composition as described above.

A further embodiment of the present invention relates to a molded article containing a composition as described above. The molding is in particular effected by injection, blow, compression, roto-molding or slush-molding or extrusion.

The compounds of the present invention may be prepared by a process, characterized by reacting a compound of formula II 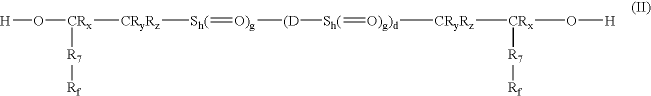
with at least one compound selected from the group consisting of R₂—COOH, R₂—COCl, R₂—COOR₉, HOOC—R₃—COOH, ClOC—R₃—COCl, R₉OOC—R₃—COOR₉, HOOC—R₆—COOH, ClOC—R₆—COCl, R₉OOC—R₆—COOR₉, R₄—O—COCl, R₅—Cl, R₅—Br and R₅—I; whereby R₂, R₃, R₄, R₅, R₆, R₇, Rₓ, R_{y}, R_{z}, h, g, d, m, p, D and R_{f} are as defined above and R₉ is C₁-C₅alkyl.

A number of methods for preparing compounds of formula II are disclosed in U.S. Pat. No. 5,693,747.

The esters, polyesters, carbonates and ethers of this invention can be prepared in per se known manner. Ester of formula I may be prepared by reacting diols of formula II with carbonic acid chlorides, esters or carboxylates. Polyester of formula I may be prepared by reacting diols of formula II with compounds containing at least two acid chlorides, esters or carboxylates groups. Carbonates of formula I may be prepared by reacting diols of formula II with chloroformates. Ethers of formula I may be prepared by reacting diols of formula II with halogenides such as chlorides, bormides or iodides. These and other methods to prepare esters, polyesters and ethers that may be used to prepare the esters, polyesters, ethers and carbonates of this invention are for example described in J. March, Advanced Organic Chemistry: Reactions, Mechanisms, and Structures, McGraw-Hill Kogakusha, Ltd., Tokyo, 1968 and in the literature cited therein. Such carbonates may be prepared according to the method disclosed for example in Y. Lee and 1. Shimizu, SYNLETT (1998), p. 1063-1064.

The following examples illustrate the invention further. Parts or percentages relate to weight unless otherwise stated. 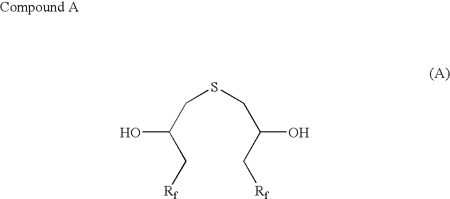
R_{f}=mixture of perfluorinated linear C₆-C₁₂alkyl
Abbreviations:
AATCC American Association of Textile Chemists and Colorists
INDA Association of the Nonwoven Fabrics Industry
PD polydispersity index (measured by gel permeation chromatography using styrene as referring standard)

### EXAMPLE 1

### Preparation of Compound 101

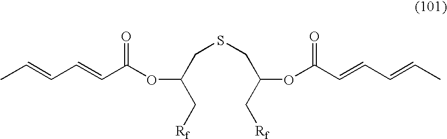

In a 2 l round bottom flask equipped with a mechanic stirrer and a Dean-Stark apparatus, surmounted by a refrigerator, is charged, under nitrogen atmosphere, 80.00 g of compound A, 850 ml of xylene, 32.66 g of 2,4-hexadienoic acid and 7.89 g of p-toluene sulfonic acid. The mixture is refluxed for 6 h at 140° C. then cooled to room temperature. The mixture is washed twice with a 15% w/v solution of K₂CO₃ and once with brine. After evaporation of the solvents 75.93 g (81% yield of theory) of the title compound is obtained as amber resin. Mₙ=1362, M_{w}=1420, PD=1.04 (negative polarity). ¹H NMR: (300 MHz, acetone d₆), δ=7.25 (m, 1H, CH═); 6.15 (m, 2H, 2CH═); 5.70 (d, 1H, J=15 Hz, CH═); 5.40 (m, 1H, CH—O); 2.85 (m, 2H, CH₂); 2.50 (m, 2H, CH₂), 1.80 (m, 3H, CH₃).

### EXAMPLE 2

### Preparation of Compound 102

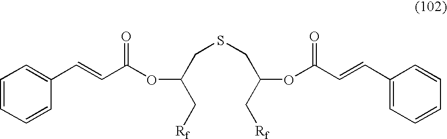

In a 250 ml round bottom flask equipped with a refrigerator is charged, under nitrogen atmosphere, 5.0 g of compound A, 90 ml of xylene, 1.11 g of dimethylamino pyridine and 1.63 g of cinnamoyl chloride. The mixture is refluxed at 140° C. for 4 hours then cooled to room temperature. The mixture is filtered and the organic phase obtained is washed twice with 1 N HCl, then with a 20% w/v solution of NaOH and finally with a 15% w/v solution of K₂CO₃. After evaporation of the solvents 4.12 g (67% yield of theory) of the title compound is obtained as yellow wax. Mₙ=1352, M_{w}=1364, PD=1.0. ¹H NMR: (400 MHz, acetone d₆), δ=7.64 (d, 2H, COCH═, J=16.0 Hz), 7.53 (m, 4H, ArCH), 7.30 (m, 6H, ArCH), 6.47 (dd, 2H, CH═, J=16.0, 7.3 Hz), 3.01 (m, 4H, CH₂), 2.73 (m, 4H, CH₂S).

### EXAMPLE 3

### Preparation of Compound 103

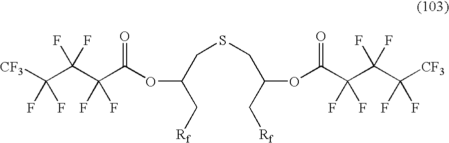

In a 250 ml round bottom flask is charged, under nitrogen atmosphere, 5.0 g of compound A, 90 mL of methyl isobutyl ketone, 1.11 g of dimethylamino pyridine and 2.06 g of perfluorobutyryl chloride. The mixture is kept at room temperature for 24 h then is filtered. The organic phase is washed twice with 1 N HCl then once with brine. After evaporation of the solvent 4.89 g (82% yield of theory) of the title compound is obtained as yellow oil. Mₙ=1159, M_{w}=1299, PD=1.12. ¹H NMR: (300 MHz, CDCl₃), δ=5.60 (m, 2H, CHO), 2.94 (m, 4H, CH₂), 2.67 (m, 4H, CH₂).

### EXAMPLE 4

### Preparation of Compound 104

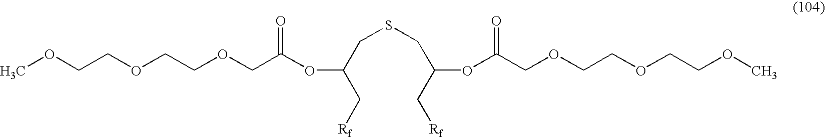

In a 250 ml round bottom flask equipped a refrigerator were charged, under nitrogen atmosphere, 10.0 g of compound A, 140 ml of xylene, 4.7 g of 2-[2-(2-methoxyethoxy)ethoxy]acetic acid and 1.03 g of p-toluensolfonic acid. The mixture is refluxed for 6 hours then cooled to room temperature. The mixture is filtered and the organic phase obtained is washed twice with a 20% weight solution of K₂CO₃. After evaporation of the solvents 8.6 g (67% yield) of the title compound are obtained as brown oil. Mn=1284, Mw=1456, PD=1.13. ¹H NMR: (400 MHz, CDCl₃), δ=5.42 (m, 2H, CHO), 4.11 (m, 4H, CH₂O), 3.70-3.55 (m, 12H, CH₂O), 3.49 (m, 4H, CH₂O), 3.30 (s, 6H CH₃O), 2.78 (m, 4H, CH₂O), 2.50 (m, 4H, CH₂O).

### EXAMPLE 5

### Preparation of Compound 105

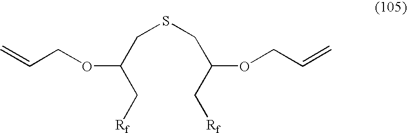

In a 250 ml round bottom flask are charged, under nitrogen atmosphere, 9.0 g of compound A, 150 ml of methyl isobutyl ketone, 1.28 g of NaOH and 4.83 g (3.4 mL) of allyl bromide. The mixture is kept at 60° C. for 72 h then filtered. The organic phase is washed once with water. After evaporation of the solvent 8.76 g (91% yield of theory) of the title compound is obtained as orange oil. Mₙ=1155, M_{w}=1215, PD=1.05. ¹H NMR: (300 MHz, CDCl₃), δ=5.91 (m, 2H, 2CH═), 5.27 (m, 4H, 2CH₂═), 4.06 (m, 4H, 2=CHCH₂), 3.97 (m, 2H, 2CHO), 2.85 (m, 4H, 2CH₂), 2.44 (m, 4H, 2CH₂).

### EXAMPLE 6

### Water and Oil Repellency in Polypropylene

a) In order to determine the repellency properties of the synthesized compounds, they are tested according to the following procedure. The sample preparation is a combination of polypropylene (PP) nonwovens and the additive and a thermal treatment (e.g. 130° C. for 10 minutes), which enables the migration of the additive to the surface and a proper surface rearrangement of the chemical groups. This extra heat cycle is needed to melt the fluorochemical to obtain a homogeneous redistribution over the surface of the substrate.

An industrial sample of polypropylene nonwoven, fabric weight: 40 g/m², is dipped into a 1% isopropanol solution of the test compound, simultaneously applying ultrasonic energy for one minute. After that, the sample is dried overnight at room temperature and then two hours at 90° C. in an oven. A part of the sample is afterwards annealed for 10 minutes at 130° C.

b) The treated nonwoven samples are evaluated in the water repellency test similar to INDA test method 80.8 (99). The wetting behavior of the nonwovens is tested with a series of water/isopropanol mixtures. The observation of the wetting behavior is rated from 0 (water wetting, no repellency) to 10 (optimum water repellency). The results are summarized in Table 1.

c) The treated nonwoven samples are evaluated in the oil repellency test similar to AATCC test method 118-1997/ISO 14419. This test follows the same concepts of the already described water repellency test method, but using, as test solvents, a series of hydrocarbons. The observation of the wetting behavior is rated from 0 (no repellency) to 8 (optimum repellency). The results are summarized in Table 1.

TABLE 1

| | | Water repellency | Water repellency |
|---|---|---|---|
| Example | Compound | after drying | after annealing |
| 6a^{a)} | — | 2 | 2 |
| 6b^{b)} | 101 | 10 | 10 |
| 6c^{b)} | 102 | 9 | 8 |
| 6d^{b)} | 103 | 5 | 4 |
| 6e^{b)} | 104 | 4 | 4 |
| 6f^{b)} | 105 | 6 | 4 |

TABLE 2

| | | Oil repellency | Oil repellency |
|---|---|---|---|
| Example | Compound | after drying | after annealing |
| 6g^{a)} | — | 0 | 0 |
| 6h^{b)} | 101 | 8 | 8 |
| 6i^{b)} | 102 | 5 | 1 |
| 6j^{b)} | 104 | 8 | 7 |
| 6k^{b)} | 105 | 2 | 4 |

^{a)}Comparative Example.
^{b)}Example according to the invention.

1. A compound of the formula I 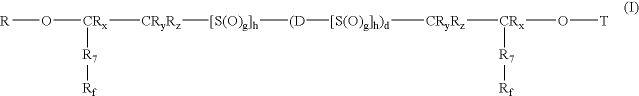
wherein
T is H or R;
R is independently R₁, —CO—R₂, —CO—R₃—COOH, —COO—R₄ or R₅;
R₁ is independently 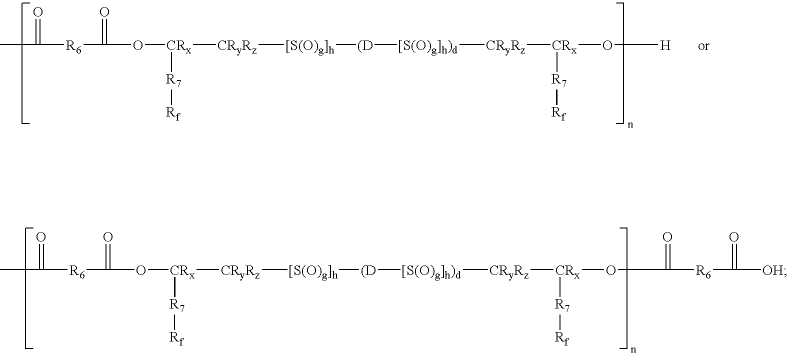
R₂ is independently C₃-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl, C₂-C₅-alkoxycarbonyl or C₂-C₅-alkanoyloxy; or R₂ is independently 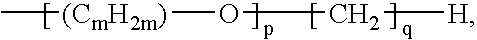
a poly(tetrahydrofuran) residue, a poly(phenylene ether) residue or perfluorinated C₁-C₂₀alkyl;
R₃ and R₆ are independently C₄-C₂₀alkenylene or C₂-C₂₀alkynylene; whereby each of these groups is unsubstituted or substituted by one or more chlorine, bromine or C₁-C₄alkyl groups; or R₃ is independently 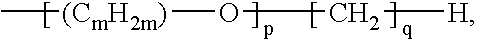
a poly(tetrahydrofuran) residue, a poly(phenylene ether) residue or perfluorinated C₁-C₂₀alkyl;
R₄ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl, C₂-C₅-alkoxycarbonyl or C₂-C₅-alkanoyloxy; or R₄ is independently 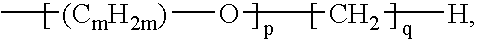
a poly(tetrahydrofuran) residue, a poly(phenylene ether) residue or perfluorinated C₁-C₂₀alkyl;
R₅ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl C₂-C₅-alkoxycarbonyl or C₂-C₅-alkanoyloxy; or R₅ is independently 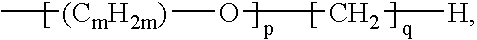
a poly(tetrahydrofuran) residue, a poly(phenylene ether) residue or perfluorinated C₁-C₂₀alkyl;
R₇ is independently a direct bond, C₁-C₆alkylene, alkyleneoxyalkylene of 2 to 6 carbon atoms, alkylenethioalkylene of 2 to 6 carbon atoms, C₁-C₆alkyleneoxy, alkenyleneoxyalkylene of 2 to 6 carbon atoms, alkylenethioalkyleneoxyalkylene of 3 to 9 carbon atoms; carbonamidoalkylene where the alkylene moiety contains 1 to 6 carbon atoms and the amido nitrogen is unsubstituted or further substituted by C₁-C₅alkyl, sulfonamidoalkylene wherein the alkylene moiety contains 1 to 6 carbon atoms and the amido nitrogen is unsubstituted or further substituted by C₁-C₅alkyl, carbonamidoalkylenethioalkylene wherein the carbonamidoalkylene moiety is as defined herein above and the thioalkylene moiety contains 1 to 6 carbon atoms, or sulfonamidoalkylenethioalkylene wherein the sulfonamidoalkylene moiety is as defined herein above and the thioalkylene moiety contains 1 to 6 carbon atoms, with the proviso that when g is 1 or 2, R₇ does not contain a thio group;
Rₓ, R_{y}, and R_{z} are independently of each other C₁-C₅alkyl or hydrogen;
h is 1 or 2;
g is 0, 1 or 2, with the proviso that when h is 2, g is 0;
d is 0 or 1;
D is C₂-C₁₀alkylene, alkyleneoxyalkylene of 4 to 10 carbon atoms, pentaerythrityl diacetate or pentaerythrityl dipropionate;
n is 1 to 20;
m is 2 to 4;
p is 2 to 30;
q is 1 or 2; and
R_{f} is independently perfluorinated alkyl, alkenyl or cycloalkyl having 3 to 20 fully fluorinated carbon atoms.

2. A compound according to claim 1, wherein T is R.

3. A compound according to claim 1, wherein
R₇ is a direct bond, —CH₂—, —CH(CH₃)—, —CH₂CH₂—O—CH₂—, —CH₂CH₂—S—CH₂—, —CH═CHCH₂—O—CH₂—, —SO₂NR₈—CH₂— or —CONH—CH₂CH₂—O—CH₂—; and
R₈ is hydrogen or C₁-C₄alkyl.

4. A compound according to claim 1, wherein Rₓ is hydrogen.

5. A compound according to claim 1, wherein R_{y} and R_{z} are hydrogen.

6. A compound according to claim 1, wherein h is 1, g is 0 and d is 0.

7. A compound according to claim 1, wherein m is 2 and p is 2 to 20.

8. A compound according to claim 1, wherein R_{f} is perfluorinated C₄-C₁₈alkyl.

9. A compound according to claim 1, wherein R₂ is independently C₄-C₂₀alkenyl, C₂-C₂₀alkynyl, C₈-C₁₆aralkenyl or C₈-C₁₆aralkynyl; or R₂ is independently 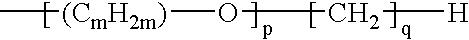
or perfluorinated C₁-C₂₀alkyl.

10. A compound according to claim 1, wherein R₃ is C₄-C₂₀alkenylene.

11. A compound according to claim 1, wherein R₄ is C₂-C₂₀alkenyl or

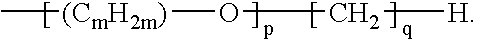

12. A compound according to claim 1, wherein R₅ is C₂-C₂₀alkenyl or

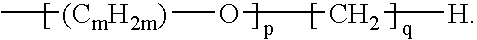

13. A compound according to claim 1, wherein R₆ is C₄-C₂₀alkenylene.

14. A compound obtained by reacting a compound of the formula II 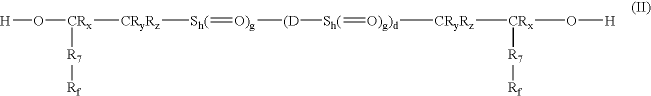
with at least one compound selected from the group consisting of R₂—COOH, R₂—COCl, R₂—COOR₉, HOOC—R₃—COOH, ClOC—R₃—COCl, R₉OOC—R₃—COOR₉, HOOC—R₆—COOH, ClOC—R₆—COCl, R₉OOC—R₆—COOR₉, R₄—O—COCl, R₅—Cl, R₅—Br and R₅—I;
R₂ is independently C₃-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl, C₂-C₅-alkoxycarbonyl or C₂-C₅-alkanoyloxy; or R₂ is independently 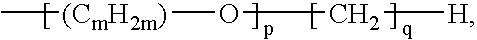
a poly(tetrahydrofuran) residue, a poly(phenylene ether) residue or perfluorinated C₁-C₂₀alkyl;
R₃ and R₆ are independently C₄-C₂₀alkenylene or C₂-C₂₀alkynylene; whereby each of these groups is unsubstituted or substituted by one or more chlorine, bromine or C₁-C₄alkyl groups; or R₃ is independently 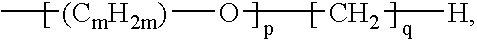
a poly(tetrahydrofuran) residue, a poly(phenylene ether) residue or perfluorinated C₁-C₂₀alkyl;
R₄ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl, C₂-C₅-alkoxycarbonyl or C₂-C₅-alkanoyloxy; or R₄ is independently 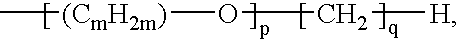
a poly(tetrahydrofuran) residue, a poly(phenylene ether) residue or perfluorinated C₁-C₂₀alkyl;
R₅ is independently C₁-C₂₀alkyl, C₆-C₁₄aryl, C₇-C₁₆aralkyl, C₂-C₂₀alkenyl, C₂-C₂₀alkynyl, C₄-C₁₀cycloalkyl, C₈-C₁₆aralkenyl or C₈-C₁₆aralkynyl; whereby each of these groups is unsubstituted or substituted by one or more hydroxy, thiol, carboxyl C₂-C₅-alkoxycarbonyl or C₂-C₅-alkanoyloxy; or R₅ is independently 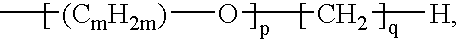
a poly(tetrahydrofuran) residue, a poly(phenylene ether) residue or perfluorinated C₁-C₂₀alkyl;
R₇ is independently a direct bond, C₁-C₆alkylene, alkyleneoxyalkylene of 2 to 6 carbon atoms, alkylenethioalkylene of 2 to 6 carbon atoms, C₁-C₆alkyleneoxy, alkenyleneoxyalkylene of 2 to 6 carbon atoms, alkylenethioalkyleneoxyalkylene of 3 to 9 carbon atoms; carbonamidoalkylene where the alkylene moiety contains 1 to 6 carbon atoms and the amido nitrogen is unsubstituted or further substituted by C₁-C₅alkyl, sulfonamidoalkylene wherein the alkylene moiety contains 1 to 6 carbon atoms and the amido nitrogen is unsubstituted or further substituted by C₁-C₅alkyl, carbonamidoalkylenethioalkylene wherein the carbonamidoalkylene moiety is as defined herein above and the thioalkylene moiety contains 1 to 6 carbon atoms, or sulfonamidoalkylenethioalkylene wherein the sulfonamidoalkylene moiety is as defined herein above and the thioalkylene moiety contains 1 to 6 carbon atoms, with the proviso that when g is 1 or 2, R₇ does not contain a thio group:
Rₓ, R_{y}, and R_{z} are independently of each other C₁-C₅alkyl or hydrogen;
h is 1 or 2;
g is 0, 1 or 2, with the proviso that when h is 2, g is 0;
d is 0 or 1;
D is C₂-C₁₀alkylene, alkyleneoxyalkylene of 4 to 10 carbon atoms, pentaerythrityl diacetate or pentaerythrityl dipropionate;
m is 2 to 4;
p is 2 to 30;
q is 1 or 2;
R_{f} is independently perfluorinated alkyl, alkenyl or cycloalkyl having 3 to 20 fully fluorinated carbon atoms; and
R₉ is C₁-C₅alkyl.

15. A composition comprising
a) a natural, synthetic or semisynthetic material, and
b) at least one compound of the formula I according to claim 1.

16. A composition according to claim 15, wherein the component (a) is a plastic material, a coating, glass, wood, paper, leather, fibre material or a textile.

17. A composition according to claim 15, wherein the component (b) is present in an amount of 0.001% to 10%, based on the weight of component (a).

18. A composition according to claim 15, comprising in addition to components (a) and (b) further additives.

19. A composition according to claim 18, comprising as further additives phenolic antioxidants, light-stabilizers and/or processing stabilizers.

20. (canceled)

21. Process for imparting oil and/or water repellency to a natural, synthetic or semisynthetic material, wherein at least one compound of the formula I according to claim 1 is applied to or incorporated into said material.
